(19) United States
(12) Patent Application Publication
(10) Pub. No.: US 2008/0290131 A1
(43) Pub. Date: Nov. 27, 2008

(54) Main Valve Driving Air Passage of Nail Gun

(76) Inventors: Chia-Sheng Liang, Taipei Hsien (TW); Chin Lung Chang, Taipei Hsien (TW)

Correspondence Address: HDSL, P.O. BOX 220746, CHANTILLY, VA, 20153-0746, US

(21) Appl. No.: 11/752,099

(22) Filed: May 22, 2007

(51) Int. Cl. B25C 1/04

(52) U.S. Cl. 227/130

(57) ABSTRACT

An air passage of a nail gun includes a fixed cylinder disposed in a gun body, and a main valve disposed at a top portion of the fixed cylinder, a trigger valve between an air collecting chamber and a main passage, an air-in passage formed in the trigger valve connecting between the air collecting chamber and the main passage, an air-out passage formed in the trigger valve connecting between the main passage and external atmosphere, and a disc-shaped valve stopper forming a main chamber. The main chamber collects the high pressure air via the air-in passage to actuate the valve stopper to move up while the valve bar is pressed, and exhausts the high pressure air in the main chamber via the air-out passage to actuate the high pressure air in the air collecting chamber to drive the valve stopper and the main valve to move down to reposit while the valve bar is released.

### BACKGROUND

The present invention relates to main valve driving air passages, and particularly to a configuration of a high pressure air passage formed between a trigger valve, a fixed cylinder and a main valve of a nail gun, for driving the main valve to open or to close.

In a typical nail gun, a main valve is fixed to a top portion of a cylinder, for being used in guiding the high pressure air into the cylinder when it is in an open state, and blocking the fluid communication toward the cylinder when it is in an off state. Moreover, a trigger valve with a valve bar is installed in the nail gun for being used in guiding the high pressure air to actuate the main valve to move up when the valve bar is pressed.

The related arts, such as TW Patent No. 439630 and TW Patent No. 1263565 respectively disclosed a fixed cylinder installed in a gun body of a nail gun. A trigger valve of the nail gun is actuated to be opened to concentrate the high pressure air for hitting nails. When a valve bar of the trigger valve is pressed to open the trigger valve, the high pressure air is guided into the fixed cylinder via a main passage to actuate a piston to move down for hitting nails. With these configurations, the main valve formed at a top portion of the cylinder is omitted.

However, a lower rate of guiding the high pressure air into the fixed cylinder detracts from a utilization efficiency of energy of the high pressure air for driving a piston to hit nails. Therefore, these configurations cannot apply to nail guns in a large scale.

Other related arts, such as U.S. Pat. No. 6,533,156, U.S. Pat. No. 6,779,699, and U.S. Pat. No. 6,006,975, respectively disclosed a separate main valve installed at a top portion of a cylinder of a nail gun. The nail gun further includes a main passage formed between the main valve and a trigger valve for concentrating the high pressure air. The trigger valve includes a valve bar, when the valve bar is pressed, the high pressure air in the main passage is exhausted and the main valve is driven to open for guiding the high pressure air into the cylinder to actuate a piston to move down to hit nails.

However, the main passage of the nail gun is over length. Then a lower rate of guiding the high pressure air into the cylinder detracts from a utilization efficiency of energy of the high pressure air for driving the piston to hit nails. In addition, it is liable to impact the reliability of the nail gun of continuously hitting nails.

Accordingly, what is needed is a main valve driving air passage of a nail gun that can overcome the above-described deficiencies.

### BRIEF SUMMARY

An exemplary main valve driving air passage of a nail gun is provided. The nail gun includes a gun body with a main valve, a fixed cylinder, an air collecting chamber, a main passage, and a trigger valve. The main valve is disposed at a top portion of the fixed cylinder. The trigger valve is disposed between the air collecting chamber and the main passage. And the air passage formed between the fixed cylinder, the main valve and the trigger valve, comprise an air-in passage formed in the trigger valve connecting between the air collecting chamber and the main passage; an air-out passage formed in the trigger valve connecting between the main passage and external atmosphere; a valve bar arranged in the trigger valve; the valve bar is capable of closing the air-in passage and opening the air-out passage while being released, and opening the air-in passage and closing the air-out passage while being pressed; and a disc-shaped valve stopper formed at a bottom portion of the main valve, the valve stopper is slidably attached between an outside surface of the fixed cylinder and an inner ring-shaped surface in the gun body. A top portion of the valve stopper is abutted by the high pressure air in the air collecting chamber, and a bottom portion of the valve stopper forms a main chamber connecting with the air-in passage and the air-out passage via the main passage.

The main chamber collects the high pressure air via the air-in passage to actuate the valve stopper and the main valve to move up while the valve bar is pressed. The main chamber exhausts the high pressure air in the main chamber via the air-out passage to actuate the high pressure air in the air collecting chamber to drive the valve stopper and the main valve to move down to reposit while the valve bar is released.

The air passage includes a plurality of rib portions surrounding the fixed cylinder and between the valve stopper and the main valve. Each two adjacent rib portions form at least one passage connecting with the air collecting chamber.

The air passage includes a spacing ring disposed between the outside surface of the fixed cylinder and an inner surface of the gun body, the inner ring-shaped surface is formed at the spacing ring, and the main chamber is formed between a top portion of the spacing ring and the bottom portion of the valve stopper.

In another illustrated structure, the air passage includes a spacing ring disposed between the outside surface of the fixed cylinder and an inner surface of the gun body, the inner ring-shaped surface is the inner surface of the gun body, and the main chamber is formed between a top portion of the spacing ring and the bottom portion of the valve stopper.

The spacing ring includes a through hole connecting between the main chamber and the main passage.

In another illustrated structure, the main chamber directly connects with the main passage.

A spring can be installed to abut one of the main valve or the valve stopper to generate downward pushing force.

A main valve port is formed between the main valve and a top portion of the fixed cylinder, as well as adjacent to the air collecting chamber. The main valve port is opened while the main valve moving up and is closed while the main valve moving down to reposit.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, cross-sectional view of part of a nail gun installing driving air passages according to an embodiment of the present invention, showing the nail gun having a trigger valve, a fixed cylinder, and a main valve with a valve stopper and a main chamber as well as a spacing ring;

FIG. 1a is an enlarged, cross-sectional view of the trigger valve of the nail gun of FIG. 1, showing the trigger valve having an air-in passage and an air-out passage connecting with a main passage, respectively;

FIG. 2 is an enlarged, cross-sectional view of part of the driving air passages of FIG. 1, showing an varied assembled structure of the main valve, the valve stopper, the main chamber, and the spacing ring;

FIG. 3 is an enlarged, cross-sectional view of part of the driving air passages of FIG. 1, showing another varied assembled structure of the valve stopper, the main chamber, and the main passage;

FIG. 4 is an enlarged, cross-sectional view of part of the driving air passages of FIG. 1, showing a spring abutting the valve stopper;

FIG. 5 is a schematic, cross-sectional view of part of the nail gun of FIG. 1, showing the nail gun in a state of before a valve bar being pressed;

FIG. 6 is a schematic, cross-sectional view of part of the nail gun of FIG. 1, showing the high pressure air being guided into the main chamber;

FIG. 7 is a schematic, cross-sectional view of part of the nail gun of FIG. 1, showing the high pressure air in the main chamber actuating the valve stopper and the main valve to move up;

FIG. 8 is a schematic, cross-sectional view of part of the nail gun of FIG. 1, showing the high pressure air being guided into the cylinder to actuate a piston to move down for hitting nails;

FIG. 9 is a schematic, cross-sectional view of part of the nail gun of FIG. 1, showing that the high pressure air in the main chamber are exhausted when the valve bar is released, so as to actuate the valve stopper and the main valve to move down to reposit for driving the piston to move up for reposition.

### DETAILED DESCRIPTION

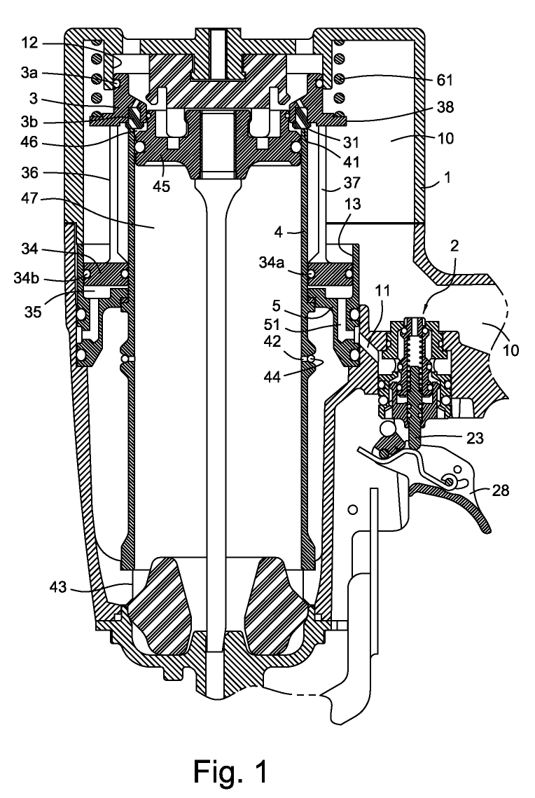

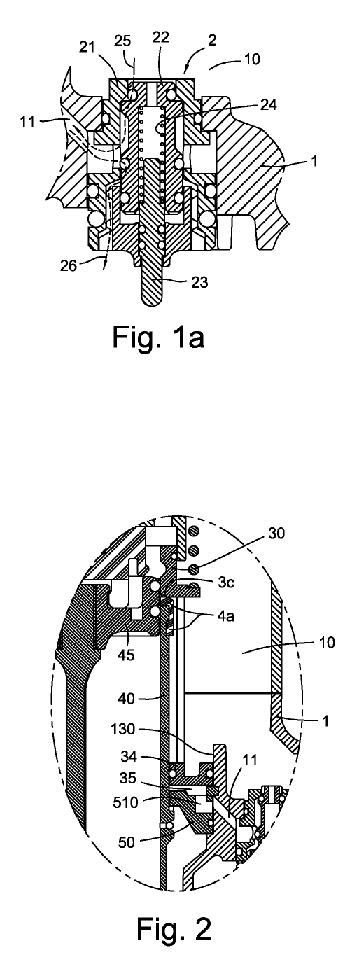

Referring to FIG. 1, a schematic, cross-sectional view of part of a nail gun installing driving air passages according to an embodiment of the present invention is shown. The nail gun includes a gun body 1 with a main valve 3, a fixed cylinder 4, an air collecting chamber 10, a main passage 11 and a trigger valve 2. The main valve 3 is disposed at a top portion of the fixed cylinder 4. The air collecting chamber 10 is capable of concentrating air and maintaining a certain high pressure therein. The trigger valve 2 is disposed between the air collecting chamber 10 and the main passage 11, and capable of guiding the high pressure air of the air collecting chamber 10 via the main passage 11 to actuate the main valve 3 to move when the trigger valve 2 is opened. Thus, the trigger valve 2, the fixed cylinder 4, and the main valve 3 cooperatively form the driving air passages.

The trigger valve 2 includes a valve base 21, a shuttle valve 22 (as shown in FIG. 1a) disposed in the valve base 21, and a valve bar 23 slidably disposed in the shuttle valve 22. The valve bar 23 is capable of being pressed, and a spring 24 is nested between the shuttle valve 22 and the valve bar 23. A trigger 28 is pivotally attached to the gun body 1 adjacent to the bottom portion of the valve bar 23.

The operator can press the trigger 28 to actuate the valve bar 23 to move up and release the trigger 28 to actuate the valve bar 23 to move down for reposition. Moreover, the trigger valve 2 forms an air-in passage 25 connecting between the air collecting chamber 10 and the main passage 11, and an air-out passage 26 connecting between the main passage 11 and external atmosphere.

The configuration of the trigger valve 2 is not limited to above illustrated embodiment. In other words, other trigger valves with a valve bar 23 that being capable of guiding the high pressure air into a main passage while being pressed can be installed in the gun body 1 according to the present invention.

The fixed cylinder 4 includes a ring-shaped top valve surface 41, a plurality of middle valve holes 42, at least one bottom through hole 43, and a valve ring 44. The valve ring 44 nests on an outside portion of the middle valve holes 42, so as to limit the middle valve holes 42 to exhaust air in a single direction only from an inside of the cylinder 4 to outside. The bottom through hole 43 is formed between a bottom portion of the cylinder 4 and an inner surface of the gun body 1. The bottom through hole 43 can also directly form at side surface of the cylinder 4. Moreover, the cylinder 4 includes a piston 45 for hitting nails, which separates the cylinder 4 into a top air chamber 46 and a bottom air chamber 47.

The main valve 3 is disc-shaped, including an air tight ring 3a disposed at an outside surface thereof, and nesting on an inner ring surface 12 of the gun body 1 for closing fluid communication. The main valve 3 also includes a valve washer 3b. The valve washer 3b and the top valve surface 41 cooperatively form a main valve port 31, adjacent to the air collecting chamber 10. The valve washer 3b can be replaced by another valve washer 4a (as shown in FIG. 2) formed at a top portion of the cylinder 40, and the top valve surface 3c is formed at a bottom portion of the main valve 30.

The main valve 3 includes a disc-shaped valve stopper 34 (as shown in FIG. 1) extended from a bottom portion thereof, which is integrated with the main valve 3. The valve stopper 34 includes an air tight ring 34a formed at an inner surface thereof, and an air tight ring 34b formed at an outside surface thereof, respectively. The valve stopper 34 is slidably attached between the outside surface of the cylinder 4 and another ring-shaped surface 13 via the air tight rings 34a, 34b. The top portion of the valve stopper 34 is abutted by the high pressure air in the air collecting chamber 10, and the bottom portion of the valve stopper 34 forms a main chamber 35 connecting with the air-in passage 25 and the air-out passage 26 via the main passage 11 (as shown in FIG. 1a).

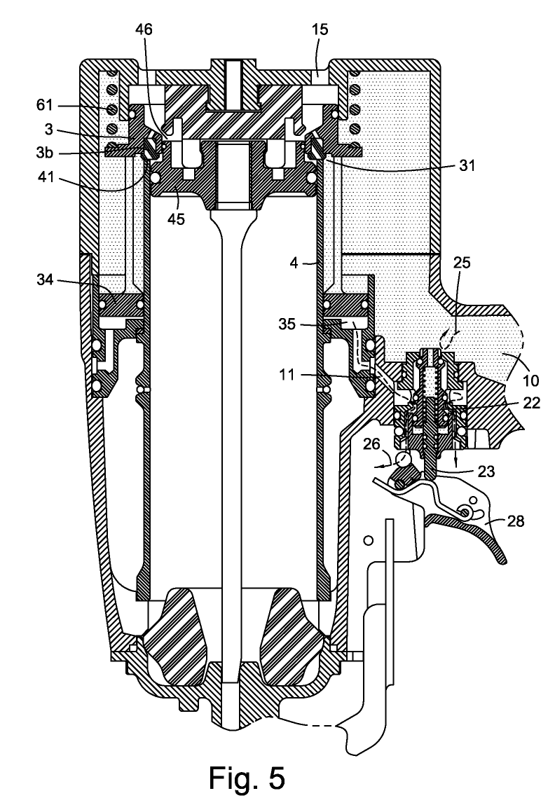

The valve stopper 34 can be formed by a plurality of integral rib portions 36 (as shown in FIG. 1) surrounding the cylinder 4 and disposed between the valve stopper 34 and the main valve 3. Each two adjacent rib portions 36 form at least one passage 37 connecting with the air collecting chamber 10 for actuating the top portion of the valve stopper 34 to sufficiently sense the pushing force of the high pressure air in the air collecting air chamber 10 (as shown in FIG. 5).

The main chamber 35 is disposed at the bottom portion of the valve stopper 34, which can be formed by a spacing ring 5 (as shown in FIG. 5) disposed between the outside surface of the cylinder 4 and the inner surface of the gun body 1. The main chamber 35 is formed between the top portion of the spacing ring 5 and the bottom portion of the valve stopper 34. The ring-shaped surface 13 can form at the spacing ring 5. In other illustrated configurations, the ring-shaped surface 130 can form at the inner surface of the gun body 1 (as shown in FIG. 2).

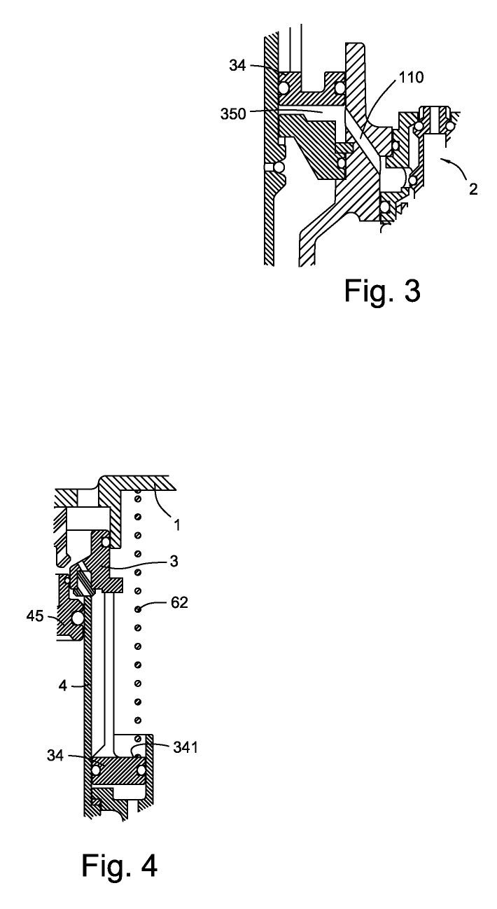

The main chamber 350 can directly connect with the main passage 110 (as shown in FIG. 3), or each of the spacing rings 5, 50 (as shown in FIGS. 1 and 2) forms a through hole 51, 510, respectively, for connecting between the main chamber 350 and the main passage 11.

In another illustrated configurations, the main valve 3 includes a integral rib ring 38 (as shown in FIG. 1) extended from an outside surface thereof, which is used for disposing a spring 61 between the main valve 3 and the inner surface of the gun body 1. Or the valve stopper 34 forms a carrying surface 341 (as showing FIG. 4) for disposing an equivalent spring 62. The springs 61 and 62 generate pushing force for actuating the valve stopper 34 to move down.

In operation, before actuating the valve bar 23 to move up via pressing the trigger 28 (as shown in FIG. 5) and the air collecting chamber 10 concentrating air and maintaining a certain high pressure therein, the high pressure air in the air collecting chamber 10 actuates the shuttle valve 22 to move up to close the air-in passage 25 and open the air-out passage 26, so as to prevent the high pressure air in the air collecting chamber 10 from transforming into the main passage 11 and the main chamber 35 via the trigger valve 2. At the same time, the main valve 3 and the valve stopper 34 are actuated to move down that is driven by the high pressure air in the air collecting chamber 10 and the downward pushing force generated by the spring 61. Then the valve washer 3b presses on the top valve surface 41 of the cylinder 4 to close the main valve port 31, for closing the fluid communication between the air collecting chamber 10 and the top air chamber 46. The main valve 3 opens an upper air exhausting hole 15 at the top portion of the gun body 1 to exhaust residual high pressure air in the top air chamber 46 to external atmosphere.

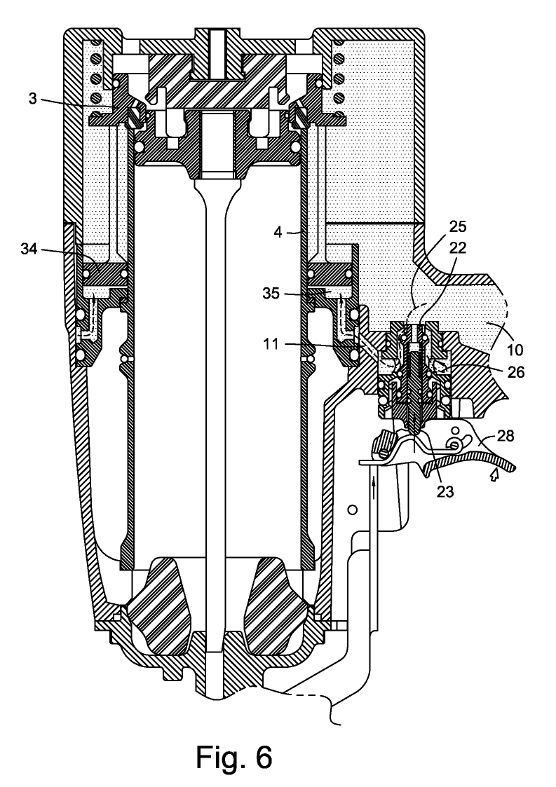

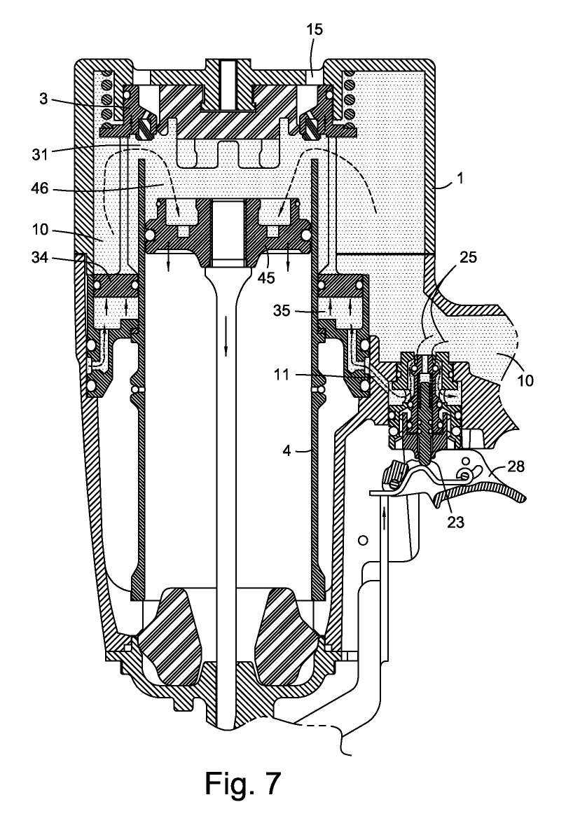

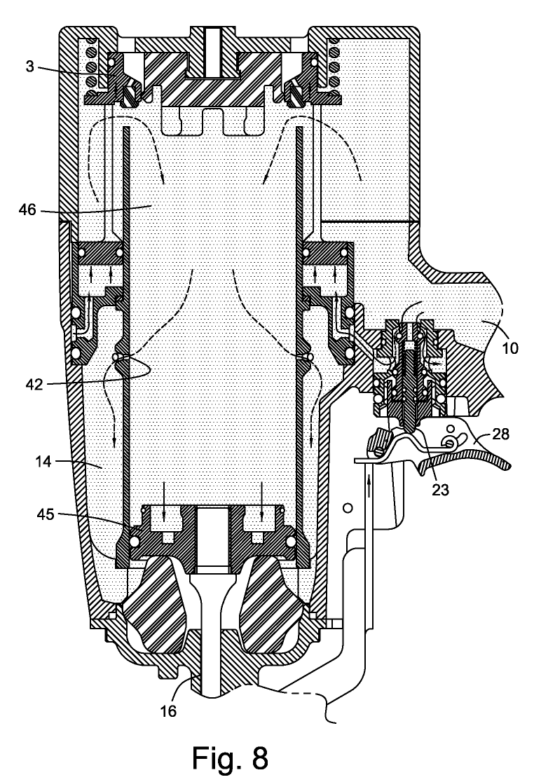

When the valve bar 23 is actuated (as shown in FIG. 6), the high pressure air in the air collecting chamber 10 drives the shuttle valve 22 to move down to close the air-out passage 26 and open the air-in passage 25. The high pressure air in the air collecting chamber 10 is continuously guided into the main chamber 35 via the main passage 11, and generates a pushing force to actuate the valve stopper 34 to push the main valve 3 to move up (as shown in FIG. 7). At the same time, the upper air exhausting hole 15 is closed by the main valve 3, and the main valve 3 opens the main valve port 31 to guide the high pressure air in the air collecting chamber 10 into the top air chamber 46 for driving the piston 45 to move down to hit nails. When the piston 45 moves down and exceeds the position of the middle valve holes 42 (as shown in FIG. 8), the high pressure air in the top air chamber 46 is guided into a return chamber 14 via the middle valve holes 42, and then the piston 45 closes a bottom air exhausting hole 16 when it moves down to a bottom position.

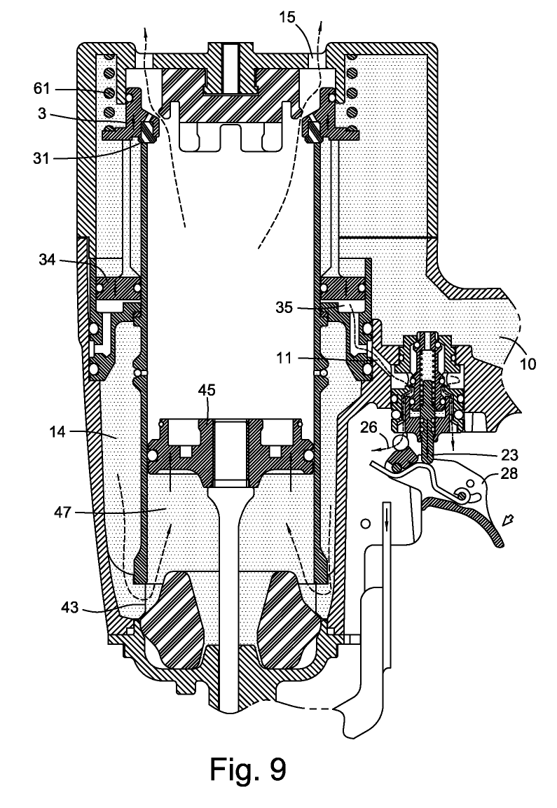

When the valve bar 23 is released to move down (as shown in FIG. 9), the high pressure air in the main chamber 35 is exhausted to external atmosphere via the main passage 11 and the air-out passage 26, so that the high pressure air in the air collecting chamber 10 and the spring 61 actuates the main valve 3 and the valve stopper 34 to move down to reposit. At the same time, the upper air exhausting hole 15 is opened and the main valve 3 closes the main valve port 31, and the high pressure air in the return chamber 14 is guided into the bottom air chamber 47 via the bottom through hole 43 to drive the piston 45 to move up to reposit. After that, the gun body 1 returns to the state before the valve bar 23 being actuated to move up.

Compared to the related art, the air passage is installed by a fixed cylinder, a main vale disposed on the fixed cylinder, and a valve stopper. With these configurations, the valve stopper can extend the sensing position of the main valve that is pressed by the high pressure air in the main chamber, which reduce the length of the main valve and improve a utilization efficiency of energy of the high pressure air for driving a piston to hit nails.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A main valve driving air passage of a nail gun, the nail gun having a gun body with a main valve, a fixed cylinder, an air collecting chamber, a main passage and a trigger valve; the main valve being disposed at a top portion of the fixed cylinder, the trigger valve being disposed between the air collecting chamber and the main passage, and the air passage being formed between the fixed cylinder, the main valve and the trigger valve, the main valve driving air passage comprising:
an air-in passage formed in the trigger valve connecting between the air collecting chamber and the main passage;
an air-out passage formed in the trigger valve connecting between the main passage and external atmosphere;
a valve bar arranged in the trigger valve, the valve bar being capable of closing the air-in passage and opening the air-out passage while being released, and opening the air-in passage and closing the air-out passage while being pressed; and
a disc-shaped valve stopper formed at a bottom portion of the main valve, the valve stopper being slidably attached between an outside surface of the fixed cylinder and an inner ring-shaped surface in the gun body, and a top portion of the valve stopper being abutted by the high pressure air in the air collecting chamber, a bottom portion of the valve stopper forming a main chamber connecting with the air-in passage and the air-out passage via the main passage;
wherein the main chamber collects the high pressure air via the air-in passage to actuate the valve stopper and the main valve to move up while the valve bar is pressed, and the main chamber exhausts the high pressure air in the main chamber via the air-out passage to actuate the high pressure air in the air collecting chamber to drive the valve stopper and the main valve to move down to reposit while the valve bar is released.

2. The main valve driving air passage as claimed in claim 1, further comprising a plurality of rib portions surrounding the fixed cylinder and between the valve stopper and the main valve, each two adjacent rib portions forming at least one passage connecting with the air collecting chamber.

3. The main valve driving air passage as claimed in claim 1, further comprising a spacing ring disposed between the outside surface of the fixed cylinder and an inner surface of the gun body, the inner ring-shaped surface forming at the spacing ring, and the main chamber forming between a top portion of the spacing ring and the bottom portion of the valve stopper.

4. The main valve driving air passage as claimed in claim 1, further comprising a spacing ring disposed between the outside surface of the fixed cylinder and an inner surface of the gun body, the inner ring-shaped surface is the inner surface of the gun body, and the main chamber forming between a top portion of the spacing ring and the bottom portion of the valve stopper.

5. The main valve driving air passage as claimed in claim 3, wherein the spacing ring comprises a through hole connecting between the main chamber and the main passage.

6. The main valve driving air passage as claimed in claim 1, wherein the main chamber connects with the main passage.

7. The main valve driving air passage as claimed in claim 1, further comprising a spring abutting one of the main valve or the valve stopper to generate downward pushing force.

8. The main valve driving air passage as claimed in claim 1, further comprising a main valve port forming between the main valve and a top portion of the fixed cylinder, as well as adjacent to the air collecting chamber, the main valve port being opened while the main valve moving up and being closed while the main valve moving down to reposit.
